(19) United States
(12) Patent Application Publication
(10) Pub. No.: US 2019/0096366 A1
(43) Pub. Date: Mar. 28, 2019

(54) DATA PROCESSING METHOD, CLIENT DEVICE, AND NON-TRANSITORY RECORDING MEDIUM HAVING A PROGRAM RECORDED THEREON

(71) Applicant: CASIO COMPUTER CO., LTD., Tokyo (JP)

(72) Inventors: Naoki AKAE, Fussa-shi (JP); Hiroyuki SHIBUSAWA, Musashino-shi (JP)

(73) Assignee: CASIO COMPUTER CO., LTD., Tokyo (JP)

(21) Appl. No.: 16/132,597

(22) Filed: Sep. 17, 2018

(30) Foreign Application Priority Data
Sep. 27, 2017 (JP) 2017-185672

(51) Int. Cl. G09G 5/12; G06F 3/14

(52) U.S. Cl. CPC G09G 5/12; G06F 3/1454

(57) ABSTRACT

A data processing method includes receiving input data for designating a function expression and at least one type of operation to be executed using the function expression without receiving a request for sharing a result of operation corresponding to the received operation, executing the operation, and transmitting the result of the executed operation without storing the result, re-receiving the input data, and receiving the request for sharing the result of the operation corresponding to the re-received operation along with the input data, re-executing the operation corresponding to the re-received operation, and storing a result of the re-executed operation and at least one pointer corresponding to the result of the operation one-to-one so that the result of the re-executed operation is associated with the pointer.

### CROSS-REFERENCE TO RELATED APPLICATIONS

This application is based upon and claims the benefit of priority from the prior Japanese Patent Application No. 2017-185672, filed Sep. 27, 2017, the entire contents of which are incorporated herein by references.

### BACKGROUND

### 1. Technical Field

The present invention relates to a data processing method, a client device, and a non-transitory recording medium having a program recorded thereon.

### 2. Description of Related Art

A graph drawing application usable on a web browser is already known. For example, “Desmos, desmos User Guide, translated by Yoshito Horikawa” released on the Internet (https://desmos.s3.amazonaws.com/Desmos_User_Guide_JA.pdf) (retrieved on Sep. 27, 2017) is a document related to an application that operates on a web browser, and it describes that an operation is performed based on a function expression input in an expression list by a user, and a graph based on a result of the operation is drawn.

In a web application that performs an operation from reception of input of a function expression for graph drawing on a web browser of a client device, an arithmetic algorithm is disclosed. In contrast, in a web application in which function expression data input into a client device is transmitted to a server apparatus, an operation is performed by the server apparatus. Here, in the client device, only the presentation of a result of the operation is performed, and it is possible to conceal the arithmetic algorithm from the client device.

Such a web application is also used in the field of school education where information and communication technology (ICT) is progressing. However, if it is hoped that a result of an operation is shared by multiple persons (e.g., students and a teacher) a result of the operation executed once by a server apparatus cannot be reused in the present circumstances.

### BRIEF SUMMARY

One embodiment of the present invention is a data processing method executed by a server, the method comprising receiving, from an outside of the server, input data which is data for designating a function expression and at least one type of operation to be executed using the function expression, the at least one type of operation being selected from one or more types of operations, without receiving a request for sharing a result of at least one operation corresponding to the received at least one type of operation, in response to the receiving the input data, executing the at least one operation based on the received input data, and transmitting at least one result of the executed at least one operation to the outside of the server, without storing the result of the executed at least one operation in a non-transitory memory, re-receiving, from the outside of the server, the input data which is the data for designating the function expression and the at least one type of operation, and receiving the request for sharing the result of the at least one operation corresponding to the re-received at least one type of operation along with the input data, in response to the re-receiving the input data, re-executing the at least one operation corresponding to the re-received at least one type of operation, based on the re-received input data, and storing, in the non-transitory memory, a result of the re-executed at least one operation and at least one pointer corresponding to the result of the at least one operation one-to-one so that the result of the re-executed at least one operation is associated with the at least one pointer.

One embodiment of the present invention, a client device which communicates with the server that executes the above-mentioned method, the client device comprising a controller and a memory, in execution by the controller, the memory has stored instructions for causing the controller to accept a user operation for inputting, in an input device of the client device, data designating a function expression, and in response to the accepting the user operation, transmit, to the outside of the client, data designating a function expression and at least one type of operation to be executed so that the server can receive the data as input data.

One embodiment of the present invention, a non-transitory recording medium having a program to cause a computer of a client device which communicates with a server that executes the above-mentioned method to accept a user operation for inputting data designating a function expression in an input device of the client device, and in response to the accepting the user operation, transmit, to the outside of the client device, data designating a function expression and at least one type of operation to be executed so that the server can receive the data as input data.

### BRIEF DESCRIPTION OF THE DRAWINGS

The components in the drawings are not necessarily to scale relative to each other.

FIG. 1 is a diagram showing one example of the entire configuration of a system.

FIG. 2 is a block diagram showing one example of the configuration of a student communication device.

FIG. 3 is a block diagram showing one example of a teacher communication device.

FIG. 4 is a block diagram showing one example of the configuration of a server.

FIG. 5 is a diagram showing one example of a display screen of a web application for preparation/sharing of graph drawing/numerical table.

FIG. 6 is a diagram showing one example of a primary process of sharing graph/numerical table.

FIG. 7A is a diagram showing one example of a process of sharing a graph.

FIG. 7B is a diagram showing one example of a process of sharing a graph.

FIG. 7C is a diagram showing one example of a process of sharing a graph.

FIG. 8 is a diagram showing one example of a display screen of a student communication device of a student A.

FIG. 9 is a diagram showing one example of the display screen of the student communication device of the student A.

FIG. 10 is a diagram showing one example of the display screen of the student communication device of the student A.

FIG. 11 is a diagram showing one example of a display screen of a student communication device of a student B.

FIG. 12 is a diagram showing one example of a display screen of the student communication device of the student B.

FIG. 13 is a diagram showing one example of the display screen of the student communication device of the student B.

FIG. 14 is a diagram showing one example of a display screen of a teacher communication device.

FIG. 15 is a diagram showing one example of a display screen of the teacher communication device.

FIG. 16 is a diagram showing one example of a display screen of the teacher communication device.

FIG. 17 is a diagram showing one example of a display screen of the teacher communication device.

FIG. 18 is a diagram showing one example of a display screen of the teacher communication device.

FIG. 19 is a diagram showing one example of a display screen of the teacher communication device.

FIG. 20 is a diagram showing one example of a relationship between a type of sharing target, and transmission information and stored information associated with the type of sharing target, in the present embodiment.

### DETAILED DESCRIPTION

An embodiment of the present invention will be described with reference to the drawings.

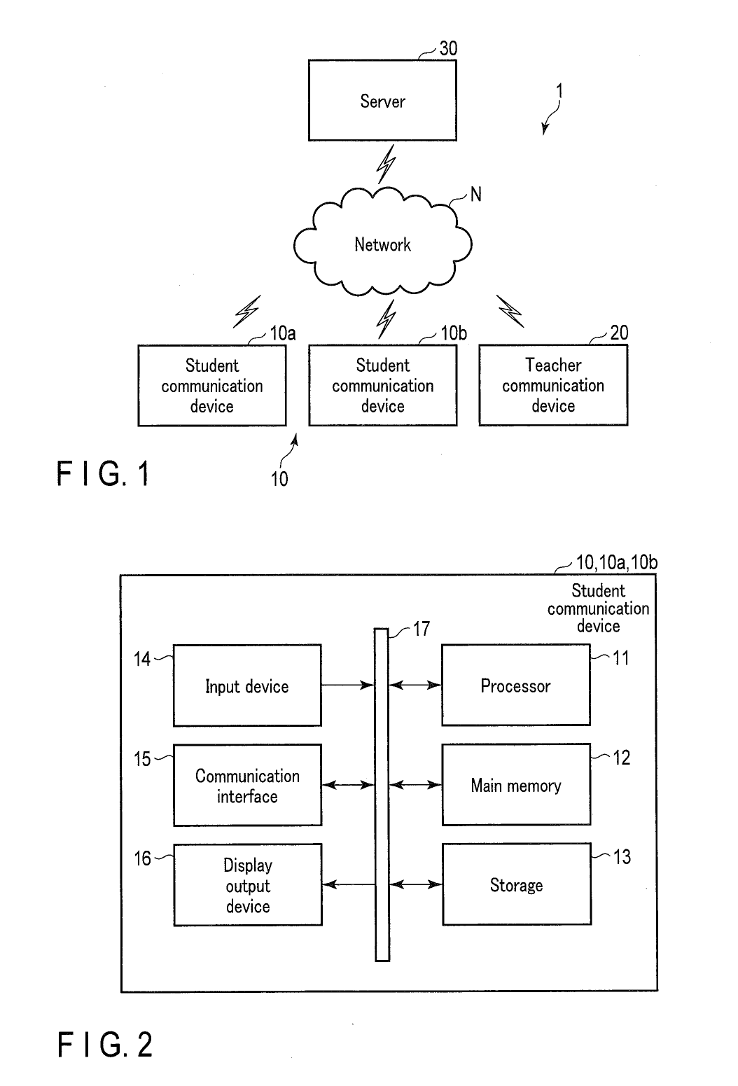

FIG. 1 is a diagram showing one example of the configuration of the entire system, including a server apparatus and a data processing device, according to the embodiment of the present invention. A system 1 includes a student communication device 10, a teacher communication device 20, and a server 30. FIG. 1 shows, as the student communication device 10, a student communication device 10a used by a student A, and a student communication device 10b used by a student B. The number of the student communication devices 10 is not limited thereto, and each student who uses the system 1 may have one student communication device 10. The communication devices 10 and 20 are communicatively connected to a server 30 via a communication network N such as the Internet. The communication devices 10 and 20 may be tablet terminals, smart phones, personal computers (PC), etc.

In the system 1, data for preparation of graph drawing/numerical table that has been input in the student communication device 10 is transmitted from the student communication device 10 to the server 30. The server 30 executes an operation based on a function expression for graph drawing/numerical table preparation, on the basis of the data, and transmits a result of the operation to the student communication device 10. The operation based on a function expression in this embodiment is an operation related to science. In this specification, the science includes natural science, cultural science, and social science, and the operation based on a function expression also encompasses a case of performing an operation based on a function expression in each science. That is, in this specification, an operation based on a function expression encompasses operations based not only on function expressions arising in the process of purely learning mathematics as one of the natural sciences, but also operations based on function expressions arising, for example, in physics or economics, etc. The student communication device 10 executes preparation of graph drawing/numerical table based on the result of the operation. The server 30 stores the result of the operation and transmits the result of the operation to the teacher communication device 20 based on a request for the result of the operation from the teacher communication device 20. The teacher communication device 20 also executes the preparation of graph drawing/numerical table based on the result of the operation. That is, in the system 1, the student communication device 10 and the teacher communication device 20 can share graphs and/or numerical tables based on data that has been input in the student communication device 10, by means of the server 30.

FIG. 2 is a block diagram showing one example of the configuration of the student communication device 10 (10a, 10b). The student communication device 10 (10a, 10b) includes a processor 11, a main memory 12, a storage 13, an input device 14, a communication interface 15, and a display output device 16. These components are connected to each other via a system bus 17.

The processor 11 may be an integrated circuit such as a central processing unit (CPU). The processor 11 reads various programs, such as a communication device control program preliminarily stored in the storage 13, and a program activated on a web browser to be developed and stored in the main memory 12 and then executes the various programs according to an input signal from the input device 14 or a reception signal received by the communication interface 15, thereby controlling each of the devices. The various programs may be downloaded from an unillustrated web server on the communication network N to the storage 13 via the communication interface 15.

The input device 14 includes external input devices, such as a keyboard, a mouse, etc., or a key input device displayed on the display output device 16 of the student communication device 10 (10a, 10b). An input signal is input in the processor 11 from an input interface (I/F) via the system bus 17 by operation of the input device 14.

The display output device 16 includes external display devices such as a liquid crystal display, or a display device such as a liquid crystal display of the student communication device 10 (10a, 10b). An output signal is transmitted from the processor 11 to the display output device 16 via the system bus 17 and the output interface (I/F).

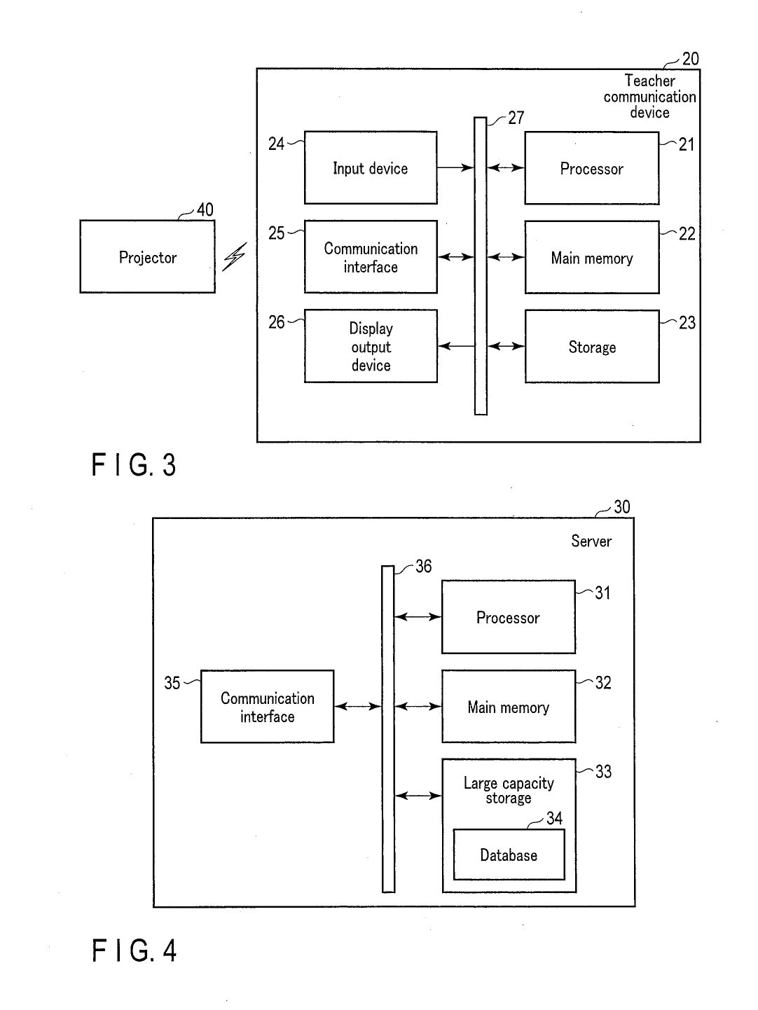

FIG. 3 is a block diagram showing one example of the configuration of the teacher communication device 20. The teacher communication device 20 includes a processor 21, a main memory 22, a storage 23, an input device 24, a communication interface 25, and a display output device 26. These components are connected to each other via a system bus 27. The teacher communication device 20 may be communicatively connected to a projector 40 via a communication interface 25.

The processor 21 may be an integrated circuit such as a CPU. The processor 21 reads various programs, such as a communication device control program preliminarily stored in the storage 23, and a program activated on a web browser to be developed and stored in the main memory 22, and then executes the various programs according to an input signal from the input device 24 or a reception signal received by the communication interface 25, thereby controlling each of the devices.

The input device 24 includes external input devices, such as a keyboard, a mouse, etc., or a key input device displayed on the display output device 26 of the teacher communication devices 20. An input signal is input in the processor 21 from an input interface (I/F) via the system bus 27 by operation of the input device 24.

The display output device 26 includes external display devices such as a liquid crystal display, or a display device such as a liquid crystal display of the teacher communication device 20. An output signal is transmitted from the processor 21 to the display output device 26 via the system bus 27 and the output interface (I/F).

FIG. 4 is a block diagram showing one example of the configuration of the server 30. The server 30 includes a processor 31, a main memory 32, a large-capacity storage 33, and a communication interface 35. These components are connected to each other via a system bus 36. The server 30 may also be connected to an unillustrated input device or unillustrated output device via an input I/F or output I/F thereof.

The processor 31 may be an integrated circuit such as a CPU. The processor 31 reads various programs such as a server control program preliminarily recorded or downloaded in the large-capacity storage 33 to be developed and stored in the main memory 32 and then retrieves an instruction of the program and decodes it, thereby controlling the operation of each of the devices based on the contents of the instruction. The processor 31 executes operation processing based on input data from the student communication device 10 (10a, 10b), or the teacher communication device 20 in accordance with a calculation processing program for preparation of graph drawing/numerical table. A result of the operation, etc. obtained by the processor 31 is stored as a database (DB) 34 in the large-capacity storage 33.

In the present embodiment, a student designates an address of the server 30 in a web browser operated on the student communication device 10 (10a, 10b), thereby a request to the server is transmitted to the server 30. A web browser of the student communication device 10 (10a, 10b) constructs a screen of a web application for preparation of graph drawing/function expression based on a response received from the server 30. The web browser of the student communication device 10 (10a, 10b) issues a request to the server 30 in response to a reception of input of data such as a function expression, and receives, as a response from the server 30, a result of the operation executed by the server 30 in accordance with the calculation processing program. In other words, the server 30 transmits, as a response, the result of the operation executed by the processor 31 in accordance with the calculation processing program to the student communication device 10 (10a, 10b) in response to the request of the operation from the student communication device 10 (10a, 10b). Furthermore, the student communication device 10 (10a, 10b) prepares graph drawing/numerical tables by the processor 11 in accordance with a program operated on a web browser, using the received result of the operation. In this way, the function as a web application for preparation of graph drawing/numerical tables is realized through cooperation between a program operated on the web browser of the student communication device 10 (10a, 10b) and the calculation processing program of the server 30. The function is also similarly realized similarly also in the teacher communication device 20.

In the present embodiment, a client device, i.e., the student communication device 10 (10a, 10b) executes only the reception of an input of data such as a function expression, and graph drawing/numerical table preparation processing, but does not execute operation processing for graph drawing/numerical table preparation. The operation processing is executed at a server apparatus, i.e., the server 30 connected to client devices via the communication network N. With this configuration, it is possible to provide a result of an operation from a sever apparatus to a client device to allow the client device to process graph drawing/numerical table preparation without disclosing a highly accurate operation algorithm. Also in the teacher communication device 20, only the graph drawing/numerical table preparation processing is executed without executing operation processing.

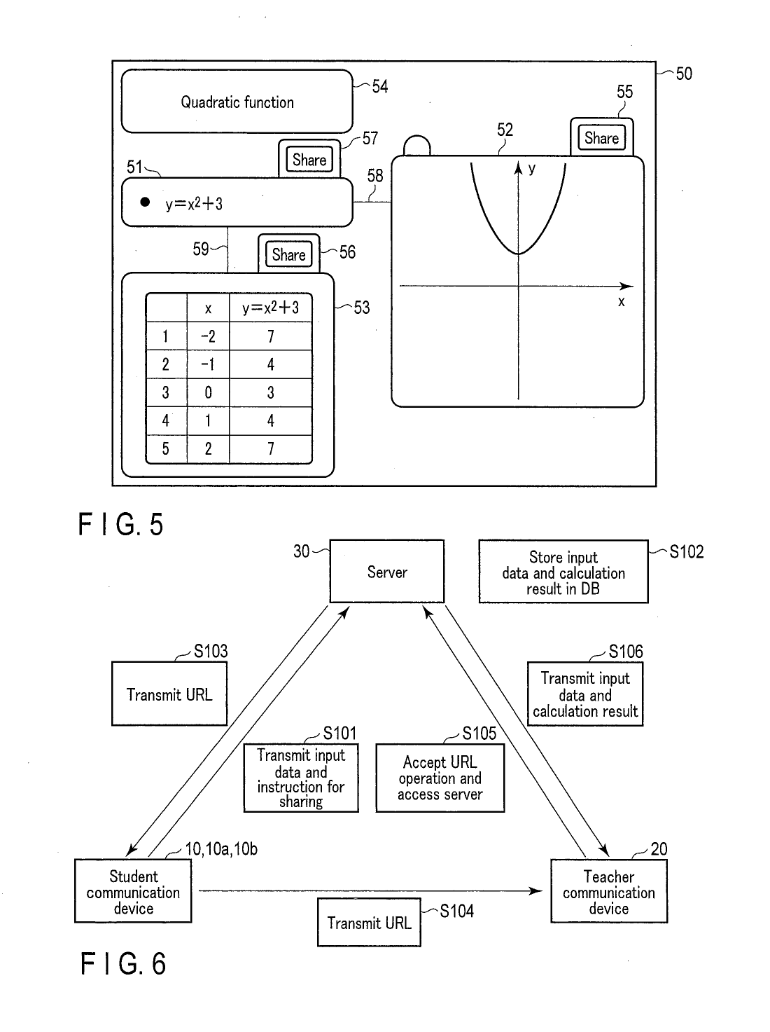

FIG. 5 is a diagram showing one example of a display screen 50 of an application for preparation/sharing of graph drawing/numerical table (hereinafter, referred to as graph drawing application) which is operated on a web browser. This graph drawing application is, as described above, a type of scientific calculator web application provided as a result of cooperation between a program operated on a web browser of a client device and a calculation processing program of a server apparatus.

The display screen 50 shown in FIG. 5 represents a screen display, for example, of the display output device 16 of the student communication device 10 (10a, 10b). Various floating objects are displayed on the display screen 50. Hereinafter, each of the objects is referred to as a “note”. FIG. 5 shows four notes which are an expression note 51, a graph note 52, a numerical table note 53, and a memo note 54.

The expression note 51 is a note for inputting a function expression, and a function expression input by a user is displayed thereon. The expression note 51 is displayed by selecting “preparation of expression note” from a menu displayed by selecting (for example, clicking or tapping, both of which may be inferred from the term “selecting” hereinafter) any place on the screen by the user.

The graph note 52 is a note for displaying a graph, and a graph based on a calculation result (coordinates of plot points) calculated by the server 30 on the basis of the determination of the function expression input is drawn and displayed thereon. The numerical table note 53 is a note for displaying a numerical table, and a numerical table based on a calculation result (numerical table values) calculated by the server 30 on the basis of the determination of the function expression input is prepared and displayed thereon. On the graph note 52 and the numerical table note 53, the user can optionally set a predetermined graph area or a numerical table area, i.e., a coordinate range or a range of values to be prepared. These settings are performed by selecting, for example, “graph range” or “numerical table range” from the menu displayed as described above and inputting a desired range.

If the user has input a function expression in an expression note 51 and has also determined it, the user can suitably set whether to prepare a graph note 52, whether to prepare a numerical table note 53, or whether to prepare both of them. This setting is performed by selecting, for example, “show/hide graph” or “show/hide numerical table” from the menu displayed by selecting the expression note 51 by the user.

The memo note 54 is a note for inputting a text, and various information optionally input by the user is displayed thereon. The memo note 54 is also displayed, for example, by selecting “preparation of memo note” from the menu displayed as in the manner described above.

Share buttons 55 and 56 are displayed on the graph note 52 and the numerical table note 53, respectively, in a state of being attached thereto. The share button 55 is selected when the user instructs the communication device to share the graph drawn on the graph note 52. The share button 56 is selected when the user instructs the communication device to share the numerical table prepared in the numerical table note 53. Similarly, a share button 57 is displayed on the expression note 51 in a state of being attached thereto. The share button 57 is selected when the user instructs the communication device to share the graph and numerical table.

In FIG. 5, the expression note 51 and the graph note 52 are bound with a line 58. The line 58 is displayed on the display output device 16 along with the expression note 51 and the graph note 52 to show that the expression note 51 and the graph note 52 are associated with each other; namely, the function expression input in the expression note 51 and the graph drawn on the graph note 52 are associated with each other. Similarly, the expression note 51 and the numerical table note 53 are bound with a line 59. The line 59 is also displayed along with the expression note 51 and the numerical table note 53 on the display output device 16 to show that the expression note 51 and the numerical table note 53 are associated with each other.

The memo note 54 is independent of the expression note 51 in the default setting; however, the memo note 54 may also be associated with the expression note 51, if necessary. The association may be performed by selecting “association” from the menu displayed by selecting one of the notes with which the user would like to associate, and then selecting the other note with which the user would like to associate. Alternatively, the communication device may have a specification in which association is performed by an operation such as drag-and-drop of the memo note 54 onto the expression note 51.

Next, with reference to FIG. 6, the summary of a graph/numerical table sharing process among the student communication device 10 (10a, 10b), the teacher communication device 20, and the server 30 in the system 1 will be described. In the present embodiment, a result of an operation executed by the server 30 on the basis of data such as a function expression input by a student is associated with unique pointer information and stored in the server 30, and the teacher is enabled to access the operation result by the pointer information provided from the student to the teacher. FIG. 6 is a diagram showing one example of a main process of graph/numerical table sharing among the student communication device 10 (10a, 10b), the teacher communication device 20, and the server 30.

The student communication device 10 (10a, 10b) transmits an instruction for sharing a graph/numerical table and input data to the server 30 (Step S101). The input data transmitted includes a function expression input in the expression note 51 by the user, the type of a sharing target (a graph or a numerical table, or both of them), a graph area of the graph note 52 or a numerical table area of the numerical table note 53, in accordance with the sharing target type, or both.

The server 30 calculates coordinates of plot points (may be referred to as “plot-point coordinates”) for graph drawing based on the input data, numerical table values for preparing a numerical table, or both, in accordance with the input data received from the student communication device 10 (10a, 10b), and further prepares a unique URL (a pointer), and stores input data (information indicated by the pointer—i.e., a function expression, the type of a sharing target, a graph area or numerical table area in accordance with the type of the sharing target, or both) and a calculation result (i.e., coordinates of plot points corresponding to the input data, numerical values, or both of them) as a series of shared data in the DB 34 so as to be associated with the prepared URL (Step S102).

The server 30 transmits the prepared unique URL to the student communication device 10 (10a, 10b) (Step S103).

The student communication device 10 (10a, 10b) transmits the received unique URL to the teacher communication device 20 via, for example, an email (Step S104). The electric mails between the student communication device 10 (10a, 10b) and the teacher communication device 20 may be transmitted or received by using a mail server outside this system.

The teacher communication device 20 accepts an operation for opening the unique URL described in the email received from the student communication device 10 (10a, 10b) and accesses the server 30 (Step S105). The operation for opening the URL corresponds to a request for transmitting the input data (information indicated by the pointer) associated with the unique URL.

The server 30 retrieves the DB 34 stored in the large-capacity storage 33 for the URL, and transmits the input data and calculation result stored in the DB 34 to the teacher communication device 20 (Step S106).

In this way, in the present embodiment, the server 30 includes an operation device configured to receive input data from the student communication device 10 (10a, 10b) and to execute an operation related to science based on the input data; a communication interface configured to transmit a result of the operation to the external device; and a control device configured, upon receipt of a sharing instruction for instructing the server to share a result of the operation from the external device, to cause a storage device to store the result of the operation and information indicating a pointer corresponding to the result of the operation one-to-one, e.g., a unique URL so as to be associated with the unique URL. The processor 31 of the server 30 serves the same functions as the above-described operation device and control device. The control device reads the result of the operation associated with the URL from the storage device when the teacher communication device 20 has accessed the URL, and transmits the result of the operation to the teacher communication device 20.

In the present embodiment, a series of shared data stored in the DB 34 in the large-capacity storage 33 of the server 30 includes data of a calculation result (plot-point coordinates or numerical table values) with a predetermined numerical value format, not image data of drawn graphs or prepared numerical tables. Graph drawing and numerical table preparation is performed by the student communication device 10 (10a, 10b) which is the client device that has received the calculation result or the teacher communication device 20 with which data of the calculation result will be shared.

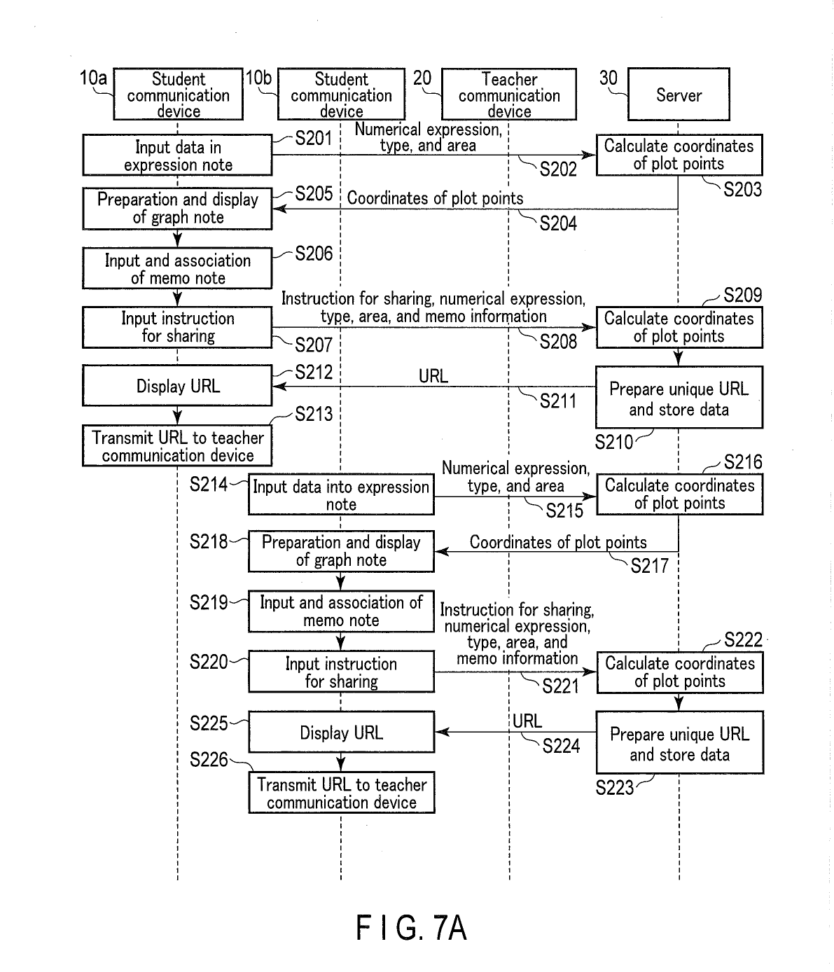

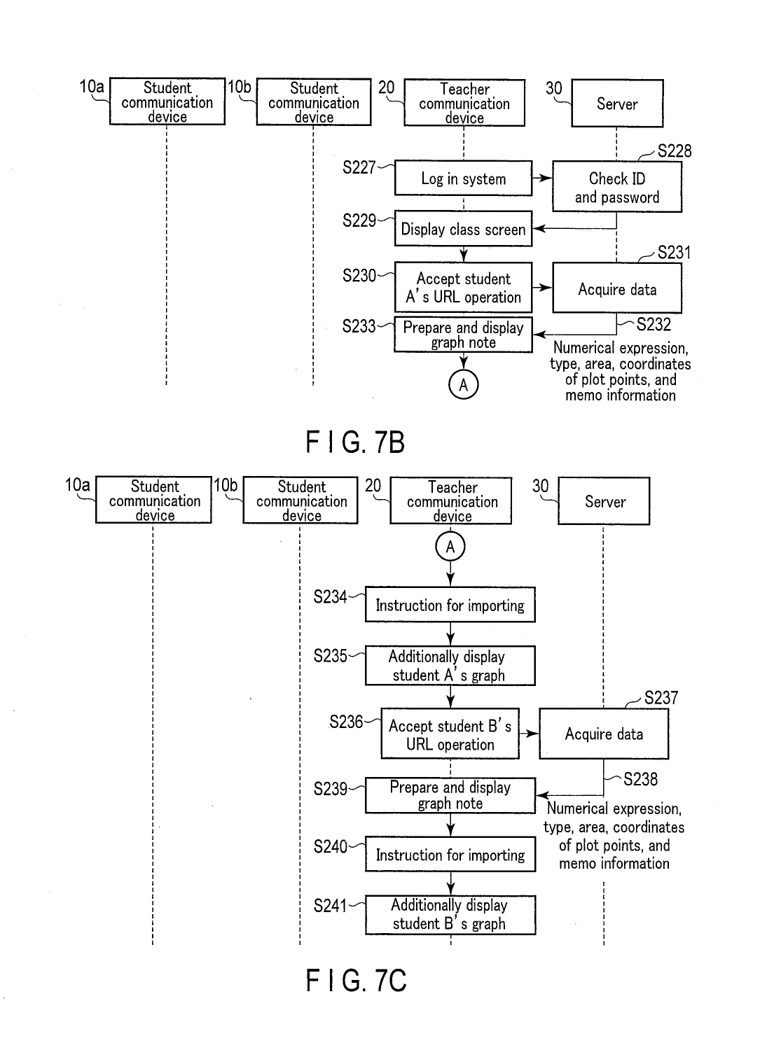

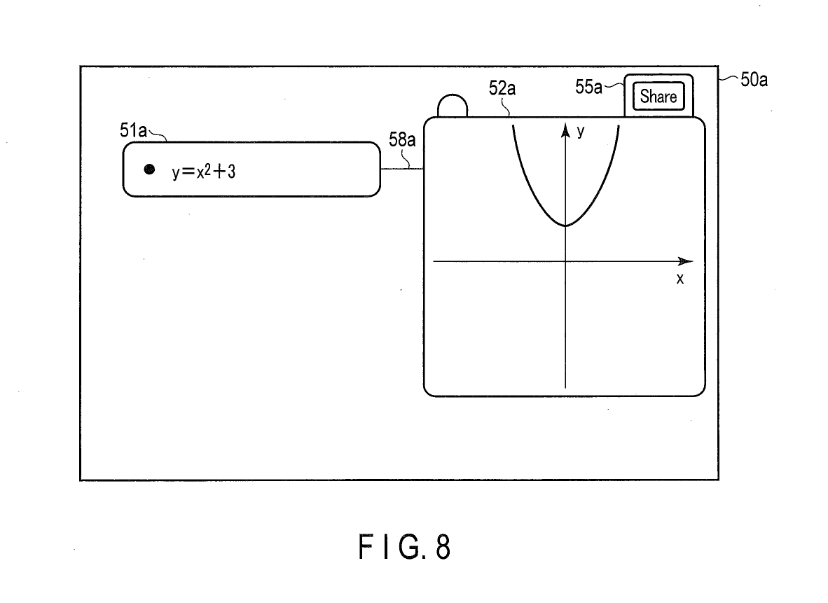

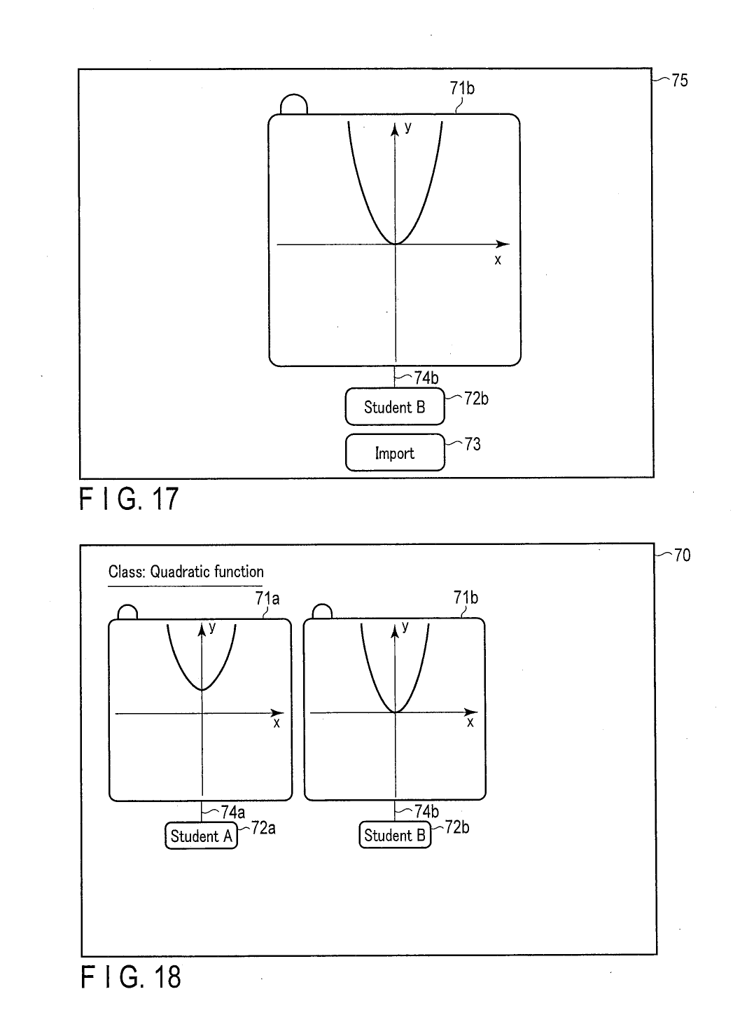

The graph-sharing process among the student communication devices 10a and 10b, the teacher communication device 20, and the server 30 will be explained in more detail. FIGS. 7A to 7C are diagrams showing one example of a graph-sharing process among the student communication devices 10a and 10b, the teacher communication device 20, and the server 30 in the system 1. Hereinafter, a series of flows in which a student A uses a student communication device 10a or a student B uses a student communication device 10b to submit an answer to a homework assignment about a quadratic function to a teacher, and the teacher causes the teacher communication device 20 to display the answer on a display output device 26 of the teacher communication device 20, will be described with reference to FIGS. 8 to 19 along with FIGS. 7A to 7C.

The student A inputs, in an expression note 51a of the student communication device 10a, a function expression, “y=x²+3” as an answer to the homework and determines it. The student communication device 10a executes processing for accepting input of the function expression in the expression note 51a and determining the expression note 51a (Step S201). By virtue of the determination processing, the student communication device 10a receives a request for graph drawing.

When the expression note 51a is determined, the student communication device 10a transmits, to the server 30, the input data, i.e., the input data of function expression “y=x²+3”, data of the type of drawing/preparation target, i.e., information that the target is a graph, and data of a graph area set for the graph note 52a (for example, “−5≤x≤5”, “−5≤y≤5” in the default setting) along with the request for graph drawing (Step S202).

The server 30 calculates coordinates of plot points to be plotted in the graph note 52a based on the input data received from the student communication device 10a in response to the request for graph drawing (Step S203).

The server 30 transmits data of plot-point coordinates calculated in step S203 as a response to the request for graph drawing to the student communication device 10a (Step S204).

The student communication device 10a prepares a graph note 52a using the coordinates of plot points received from the server 30 and displays it (Step S205). The student communication device 10a draws a graph in a graph area of the graph note 52a using the plot-point coordinates calculated by the server 30. In the student communication device 10a, as shown in, for example, FIG. 8, the expression note 51a on which the function expression “y=x²+3” is displayed, and the graph note 52a on which a graph of the function expression “y=x²+3” is drawn in the set graph area are displayed. A line 58a that binds the expression note 51a and the graph note 52a together is automatically displayed, and thereby the association of the graph note 52a with the expression note 51a is also visually displayed in an easy-to-understand manner. Furthermore, a share button 55a attached to the graph note 52a is also displayed.

When a graph is displayed on the student communication device 10a, the student A sees and checks this graph. If an intended graph is not drawn, the process from step S201 to step S205 may be repeated until the intended graph is drawn. After checking that the intended graph is drawn, the student A performs an operation for submitting this graph as a homework answer to the homework to the teacher.

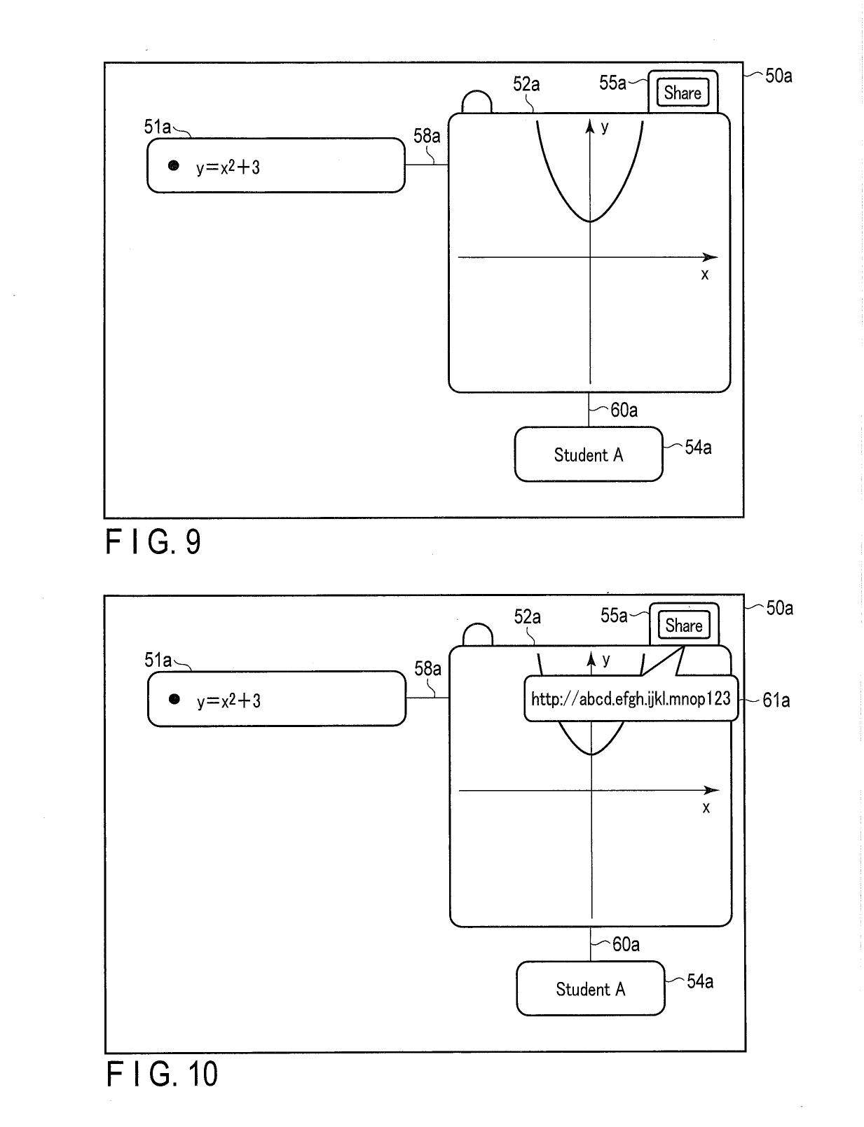

The student A causes the student communication device 10a to display a memo note 54a on a display screen 50a through a predetermined operation as described above and inputs, in the memo note 54a, identification information, such as the name or nickname of the student A. For example, FIG. 9 shows the memo note 54a in which “Student A” is input. The student communication device 10a executes processing for accepting text input into the memo note 54a and determining the memo note 54a (Step S206). In step S206, the student A associates the memo note 54a with the graph note 52a through a predetermined operation as described above. In response to the association, the student communication device 10a executes processing for associating input of the memo information in the memo note 54a with information of the function expression and the graph area used for graph drawing in the graph note 52a. Consequently, as shown in FIG. 9, for example, a line 60a that binds the graph note 52a and the memo note 54a together is displayed along with the graph note 52a and the memo note 54a, and thereby the memo note 54a being associated with the graph note 52a is also visually displayed in an easy-to-understand manner.

The student A performs an operation for giving an instruction for sharing by selecting a share button 55a. The student communication device 10a receives the operation of the instruction for sharing (Step S207). The student communication device 10a transmits, to the server 30, the function expression data, data of the sharing target type, the graph area data, memo data designating memo information, along with the instruction for sharing (Step S208). The function expression, type and graph area data transmitted in this step are identical to the function expression, type, and graph area data transmitted in Step S202. That is, the input data for preparing the graph checked by the student A is retransmitted along with the memo information associated with the input data.

It is explained above that the instruction for sharing is transmitted along with input data by the operation of selecting the share button 55a; however, the transmission of the input data and the transmission of the instruction for sharing may not be performed simultaneously. For example, after the instruction for sharing is transmitted by selecting the share button 55a, the input data may be transmitted separately.

The server 30 calculates coordinates of plot points again based on the input data received from the student communication device 10a (Step S209). The calculation performed in this step S209 is identical to the calculation performed in step S203.

Furthermore, the server 30 prepares a unique URL, and stores the unique URL, and the function expression, type, graph area data, and memo information transmitted from the student communication device 10a in step S208, and the coordinates of plot points calculated in step S209 as a series of shared data in the DB 34 so as to be associated with the prepared URL (Step S210).

In this way, in steps S201 and S202, the server 30 has not yet received the instruction for sharing, and therefore, in step S203, the server 30 merely calculates coordinates of plot points and returns the coordinates to the student communication device 10a; however, in steps S207 and S208, the server 30 has received the instruction for sharing, and therefore, the server 30 calculates the coordinates of plot points in step S209, and then stores the coordinates of plot points and the unique URL so as to be associated with one another as the DB 34 in the large-capacity storage 33 so that the information can be shared with the teacher communication device 20. That is, in steps S201 and S202, the server 30 does not perform processing for storing and maintaining the calculation result performed in step S203 so that the calculation result can be referred to later; but the load of the server 30 can be reduced by omitting the processing.

The server 30 transmits the unique URL prepared in step S210 to the student communication device 10a (Step S211).

The student communication device 10a displays the received unique URL as a URL display 61a along with the various notes 51a, 52a, and 54a on the display screen 50a, as shown, for example, in FIG. 10 (Step S212). The communication device may have a specification in which after the unique URL is received, showing/hiding the URL display 61a can be selected at any timing by the user through an operation such as selection of the share button 55a.

The student A copies and pastes the received URL, for example, in a main body of an email. The student communication device 10a executes processing for transmitting the email to the teacher communication device 20 (Step S213).

On the other hand, the student B inputs, in an expression note 51b of the student communication device 10b, a function expression “y=x²” as an answer to the homework and determine the expression note 51b. The student communication device 10b executes processing for accepting input of the function expression into the expression note 51b and determining the expression note (Step S214). In this step, in response to this determination processing, the student communication device 10b accepts a request for graph drawing.

The student communication device 10b transmits, to the server 30, input data (i.e., the input function expression “y=x²”), data of the drawing/preparation target type, the data of a graph area set for the graph note 52b along with a request for graph drawing (Step S215).

In response to the request for graph drawing, the server 30 calculates coordinates of plot points to be plotted in the graph note 52b, based on the input data received from the student communication device 10b (Step S216).

The server 30 transmits data of the coordinates of plot points calculated in step S216 as a response to the request for graph drawing to the student communication device 10b (Step S217).

The student communication device 10b prepares a graph note 52b using the information on plot points received from the server 30 and displays it (Step S218). The student communication device 10b draws a graph in a graph area of the graph note 52a using the coordinates of plot points calculated by the server 30. In the student communication device 10b, as shown in, for example, FIG. 11, the expression note 51b on which the function expression “y=x²” is displayed, the graph note 52b on which a graph of the function expression “y=x²” is drawn in the set graph area, and a line 58b that binds the expression note 51b and the graph note 52b together, and a share button 55b are displayed.

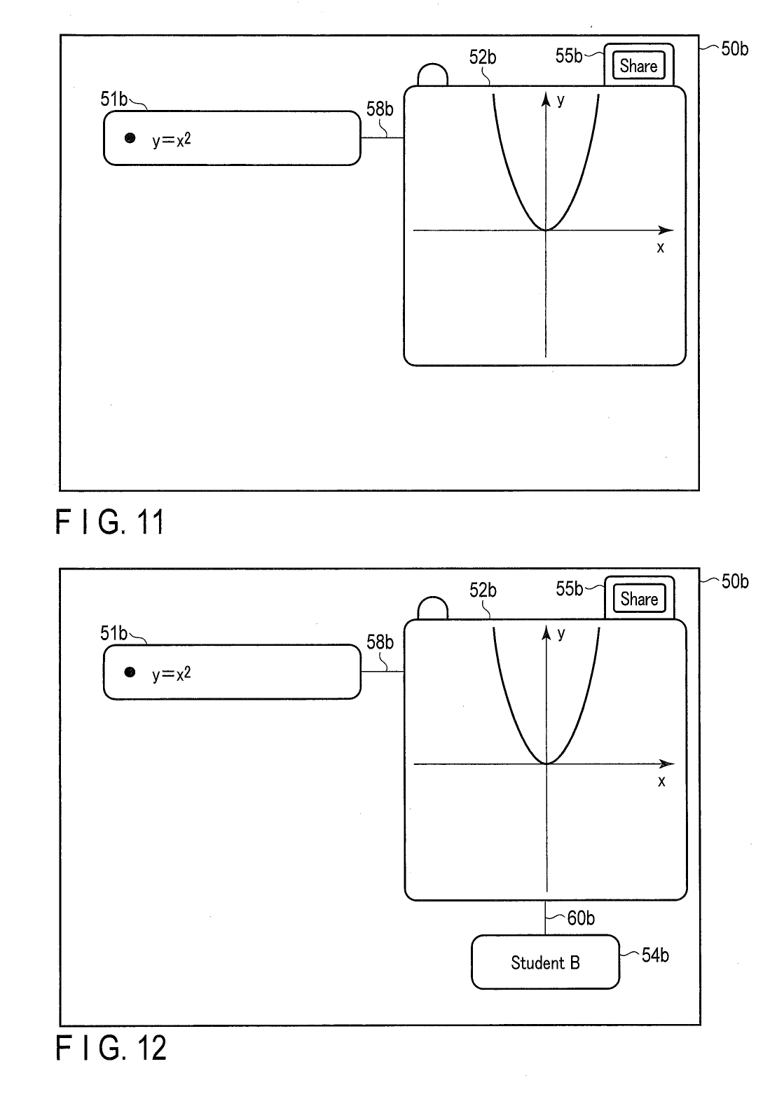

The student B inputs identification information, such as the name or nickname of the student B, in a memo note 54b of the display screen 50b. For example, FIG. 12 shows the memo note 54b in which “Student B” is input. The student communication device 10a executes processing for accepting the input of the text in the memo note 54b, and determining the memo note 54b (Step S219). In step S219, the student B associates the memo note 54b with the graph note 52b through a predetermined operation as described above. In response to the association, the student communication device 10b executes processing for associating the memo information in the memo note 54b with information about the function expression and the graph area used for graph drawing in the graph note 52b. Consequently, as shown in, for example, FIG. 12, a line 60b that binds the graph note 52b and the memo note 54b together is displayed along with the graph note 52b and the memo note 54b, and thereby the association of the memo note 54b with the graph note 52b is also visually displayed in an easy-to-understand manner.

The student B performs an operation for giving an instruction for sharing by selecting the share button 55b. The student communication device 10b accepts the operation of the instruction for sharing (Step S220). The student communication device 10b transmits, to the server 30, the function expression data, data of the sharing target type, graph area data, and memo data along with the instruction for sharing (Step S221).

The server 30 calculates coordinates of plot points based on the input data received from the student communication device 10b, in the same manner as step S216 (Step S222).

Furthermore, the server 30 prepares a unique URL, and stores the function expression, type, graph area data, and memo information transmitted from the student communication device 10a in step S221, and the coordinates of plot points calculated in step S222 so as to be associated with the prepared URL, as a series of shared data, in the DB 34 (Step S223).

The server 30 transmits the unique URL prepared in step S223 as a response to the request for graph drawing to the student communication device 10b (Step S224).

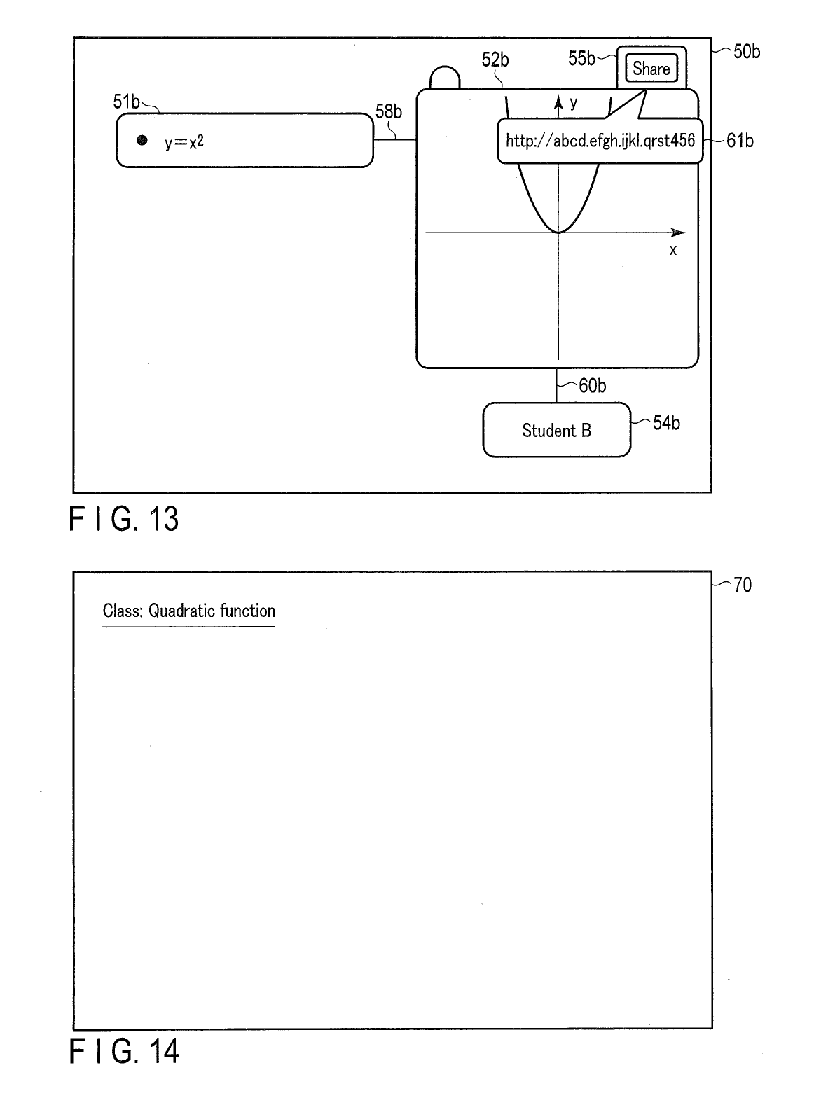

The student communication device 10b displays the received unique URL as a URL display 61b along with the various notes 51b, 52b, and 54b on the display screen 50b, as shown in, for example, FIG. 13 (Step S225). In the same manner as the student communication device 10a described above, the communication device 10b may have a specification in which after the unique URL is received, showing/hiding the URL display 61b can be selected at any timing by the user through an operation such as the selection of the share button 55b.

The student B performs copy and paste processing of the received URL, for example, in a main body of an email. The student communication device 10b executes processing for transmitting the email to the teacher communication device 20 (Step S226).

With the process described above, the submissions of answers by the students A and B end. Subsequently, the teacher shares the answers submitted by the students A and B. The teacher accesses an HP address of the server 30 to input a user ID and a password preliminarily set for login of a graph-sharing system. The teacher communication device 20 accepts the user ID and the password that have been input and transmits them to the server 30 (Step S227).

The server 30 checks the received user ID and password (Step S228). After checking the user ID and password and performing authentication processing, the server 30 executes processing for causing the teacher communication device 20 to display a class screen 70 of “Class: Quadratic function” as shown in, for example, FIG. 14. In the web browser of the teacher communication device 20, the class screen 70 is constructed based on a response from the server 30 (Step S229).

The teacher opens data designated by the URL described in the email from the student A. The teacher communication device 20 is connected to the server 30 upon receipt of the URL operation (Step S230).

The server 30 retrieves the DB 34 stored in the large-capacity storage 33 for data designated by the URL to acquire the function expression data, type-specific data, graph area data, and data of coordinates of plot points, memo information stored as a series of shared data so as to be associated with the URL (Step S231).

The server 30 transmits, to the teacher communication device 20, the acquired function expression data, type-specific data, graph area data, data of coordinates of plot points and memo information (Step S232).

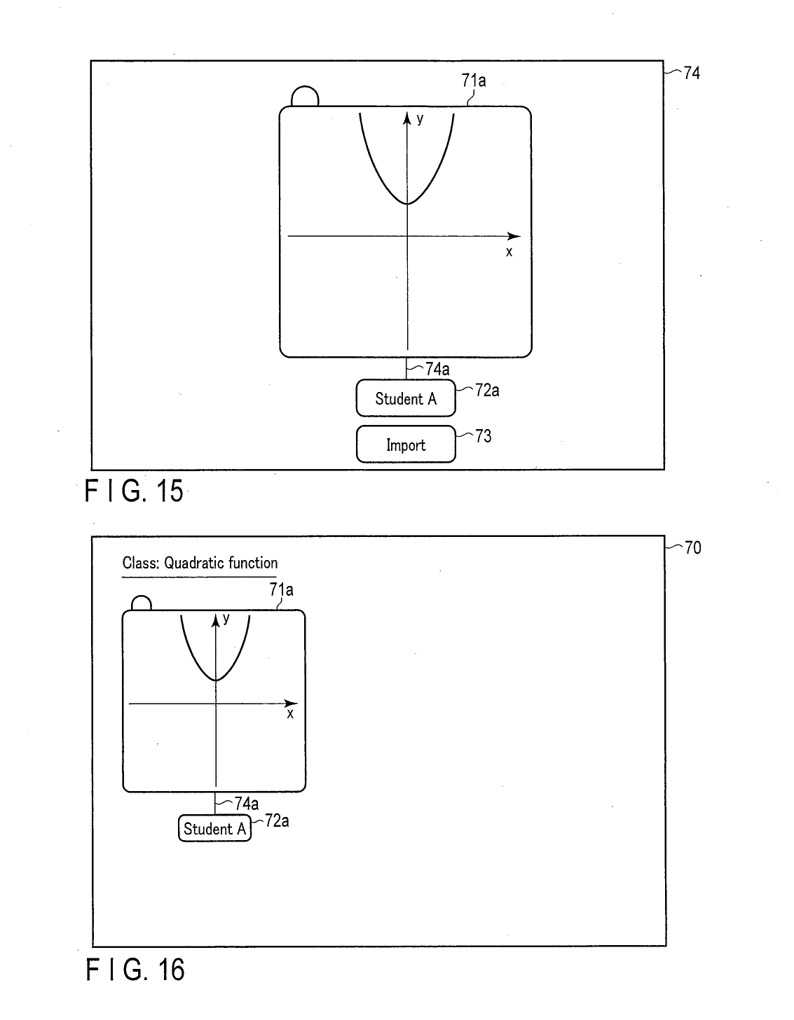

The teacher communication device 20 executes processing for preparing a graph note 71a by using the type-specific data, graph area data; and data of coordinates of plot points in the received series of shared data, and preparing a memo note 72a using the memo information (Step S233). The graph note 71a and the memo note 72a prepared in this step are floating objects. In the teacher communication device 20, as shown in FIG. 15, the graph note 71a in which a graph identical to the graph note 52a displayed on the display screen 50a of the student communication device 10a in step S205, and the memo note 72a in which contents identical to the memo note 54a displayed on the display screen 50a of the student communication device 10a in step S206, are displayed on an import screen 74 which is different from the class screen 70. An import button 73 is also displayed along with the graph note 71a and the memo note 72a. A line 74a that binds the expression note 71a and the graph note 72a together is automatically displayed, and thereby the association of the graph note 71a with the memo note 72a is also visually displayed in an easy-to-understand manner.

In step S233, the teacher communication device 20 may execute processing for preparing an expression note similar to the expression note 51a using the function expression of the received series of shared data, in accordance with the user setting. The prepared expression note may be displayed along with the graph note 71a and the memo note 72a. The communication device may have a specification in which showing/hiding the graph note 71a and the memo note 72a can be selected by the user. The same can be done also in step S239 which is described later.

The teacher selects the import button 73 displayed on the screen 74. The teacher communication device 20 receives an instruction for importing the graph note 71a and the memo note 72a (Step S234). With this, the teacher communication device 20 executes processing for importing the graph note 71a and the memo note 72a associated with the graph note 71a on the class screen 70 (Step S235). FIG. 16 shows the graph note 71a and the memo note 72a imported on the class screen 70. The communication device may have a specification in which an unillustrated cancel button is displayed on the import screen 74 shown in FIG. 15, and upon selection of the cancel button, the screen is closed without importing data, returning to the class screen 70 shown in FIG. 14.

Next, the teacher opens data designated by the URL described in an email from the student B. The teacher communication device 20 is connected to the server 30 upon receipt of the URL operation (Step S236).

The server 30 retrieves the DB 34 stored in the large-capacity storage 33 for data designated by the URL to acquire the function expression data, type-specific data; graph area data, and data of coordinates of plot points; memo information stored as a series of shared data so as to be associated with the URL (Step S236).

The server 30 transmits the acquired function expression data, type-specific data, graph area data, data of coordinates of plot points and memo information to the teacher communication device 20 (Step S238).

The teacher communication device 20 executes processing for preparing a graph note 71b using the type-specific data, graph area data, and data of plot-point coordinates in the received series of shared data and preparing a memo note 72b using the memo information (Step S239). In the teacher communication device 20, as shown in FIG. 18, the graph note 71b in which a graph identical to the graph note 52b displayed on the display screen 50b of the student communication device 10b in step S218, and the memo note 72b, in which contents identical to the memo note 54b displayed on the display screen 50b of the student communication device 10b in step S219, are displayed on the import screen 75 which is different from the class screen 70. The import button 73 is also displayed along with the graph note 71b and the memo note 72b. Similar to the case where the data designated by the URL described in the email from the student A is opened, a line 74b that binds the graph note 71b and the memo note 72b together is automatically displayed, and thereby the association of the graph note 71b with the memo note 72b is also visually displayed in an easy-to-understand manner.

The teacher selects the import button 73 displayed on the screen 75. The teacher communication device 20 accepts an instruction for importing the graph note 71b and the memo note 72b (Step S240). With this accept ion, the teacher communication device 20 executes processing for importing the graph note 71b and the memo note 72b associated with the graph note 71b in the class screen 70 (Step S241). Through the processing, as shown in FIG. 18, the graph note 71b and the memo note 72b are displayed in addition to the graph note 71a and the memo note 72a, on the class screen 70. In addition, the graph note 71a reproduced from the graph submitted by the student A and the graph note 71b reproduced from the graph submitted by the student B are displayed side-by-side on the display screen of the teacher communication device 20.

Since the teacher has already ascertained that he or she has opened a URL described by email when opening the URL, the teacher should have ascertained that the graph notes 71a and 71b are answers submitted—and by whom they have been submitted— without display, along with the graph notes 71a and 71b, the memo notes 72a and 72b which include the identification information. However, in particular, the notes 71a and 71b are respectively floating objects and are movable on the class screen 70, and therefore, if a plurality of graph notes 71a and 71b are displayed on the same class screen 70, there is a possibility that the teacher cannot ascertain who submitted each of the graph notes. To prevent this deficiency, in the above-described embodiments, the teacher communication device is configured such that the teacher can ascertain who submitted each of the notes 71a and 71b at a glance by displaying the memo notes 72a and 72b associated with each of the graph notes 71a and 71b.

In this way, in the present embodiment, the teacher communication device 20 as a data processing device includes a display device configured to access pointer information, e.g. URLs, corresponding, one-to-one, to calculation results (data of coordinates of plot points) which are calculated in the student communication devices 10a and 10b and are stored in the server 30, to receive the calculation results associated with the URLs, and to display data based on the calculation results; and a control device configured to control display of the display device. The processor 21 of the teacher communication device 20 takes on the function of the above-described control device.

In the above-described embodiments, transmissions of emails through the Internet are used as a communication tools to the URLs from the student communication devices 10a and 10b to the teacher communication device 20; however, short-range wireless communications such as Bluetooth (registered trademark), or other communication tools may be used. For example, the system may have a specification in which a user ID and a password in the graph-sharing system in step S227 and S228 are allocated to each student, and each student accesses and logs in a server HP address of the graph-sharing system and then submits a URL. Provided with such a specification, students themselves can also check their answers after preparation of the answers or submission of the answers. What is provided from the student communication device 10 (10a, 10b) is not limited to a URL, and may be unique pointer information other than the URL, such as a two-dimensional code. The system may have the specification in which the user can see shared data itself.

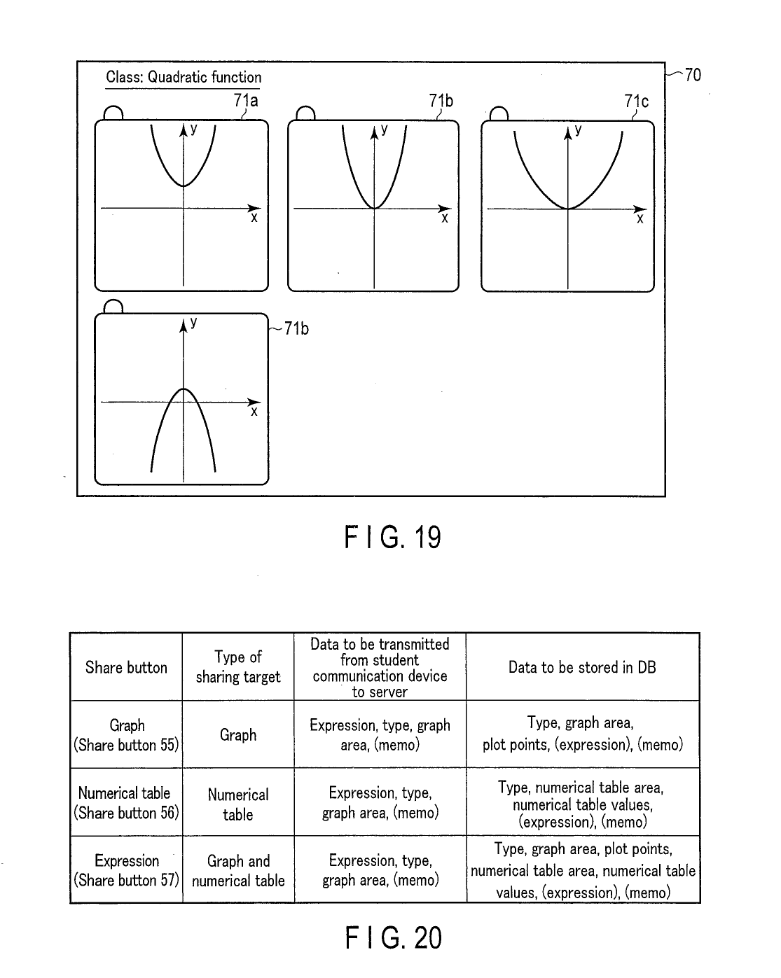

If the series of operations as described above is performed for emails from three or more students, it becomes possible to display graphs submitted by these students on the same class screen 70. For example, in FIG. 19, graphs notes 71a, 71b, 71c, and 71d, which are reproduced from graphs respectively submitted by students A, B, C, and D, are displayed on the same class screen 70, with high browsability. The teacher communication device 20 can use such a class screen 70 in a school class, etc. while projecting the class screen 70 onto a projection screen, etc. by communicating with a projector 40.

In FIG. 19, only graph notes are displayed on the class screen 70. This is, for example, a case where other notes associated with the graph notes are not present, or a case where other notes associated with the graph notes are present, but only the graph notes are imported or displayed on the class screen by the setting of the teacher communication device 20. In this way, the communication device may be configured to perform display in which a person who submitted the answer to the homework are intentionally hidden in accordance with the application.

FIG. 20 is a diagram showing one example of a relationship between a type of sharing target, and transmission information and stored information associated with the type of sharing target in the present embodiment. When the user clicks a share button 55, the type of the sharing target is a graph, and data to be transmitted from the student communication device 10 to the server 30 is the type, a function expression input in an expression note 51 and a graph area of a graph note 52. In this case, data stored as a DB 34 in the large-capacity storage 33 of the server 30 is the received type, graph area, and coordinates of plot points calculated by the server 30. If a memo note 54 associated with the graph note 52 is present, memo information of the memo note 54 may also be transmitted (See FIG. 7A). Function expression data received from the student communication device 10 may also be stored in the server 30, and if memo information of the memo note 54 associated with the graph note 52 is received, the memo information may also be stored (See FIG. 7A).

When the user clicks a share button 56, the type of the sharing target is a numerical table, and data to be transmitted from the student communication device 10 to the server 30 is the type, a function expression input in the expression note 51 and a numerical table area of the graph note 53. In this case, data to be stored in the server 30 is the received type, numerical table area, and numerical table values calculated by the server 30. Also in this case, the memo information of the memo note 54 associated with the numerical table note 53 may be transmitted to the server 30, and the received function expression data and memo information may also be stored in the server 30.

When the user clicks a share button 57, the type of sharing target is a graph and a numerical table, and information to be transmitted from the student communication device 10 to the server 30 is the type, a function expression input in the expression note 51, a graph area of the graph note 52, and a numerical table area of the graph note 53. Data to be stored in the server 30 in this case is the received type, graph area and numerical table area, and the coordinates of plot points and numerical table values calculated by the server 30. Also in this case, memo information of the memo note 54 associated with the graph note 52 or the numerical table note 53 may be transmitted to the server 30, and the received function expression data and memo information may also be stored in the server 30.

In this way, a data structure including calculation results (data of coordinates of plot points and data of numerical table values) calculated by calculation processing programs of the server 30 is stored as a DB 34 in the large-capacity storage 33 of the server 30.

It should be noted that if sharing targets preliminarily set are only graphs or numerical tables, the sharing target type data is unnecessary.

As explained above, according to the present embodiment, a server 30 is provided which enables sharing data of graph/numerical table prepared by a student through use of the student communication device 10 (10a, 10b) with the teacher communication device 20. Since the graph/numerical table received by the student communication device 10 (10a, 10b) is reused by the teacher communication device 20, it is possible to reduce the calculation volume by the server 30 and improve the operating speed. That is, redundant operations can be eliminated. Furthermore, it is possible to reduce generation of communications based on operations between a client device and a server apparatus as much as possible. Furthermore, by using unique pointer information such as a URL, data reused by the teacher communication device 20 or the student communication device 10 (10a, 10b) can be designated in the server 30 in user's first attempt.

Furthermore, in the present embodiment, emails are used for transmission/reception of URLs between the student communication device 10 (10a, 10b) and the teacher communication device 20. In the field of education today, transmission/reception via emails has been already frequently utilized as a communication tool, and communications utilizing emails are enabled. That is, it is possible to provide a use form which is easily adapted to existing circumstances.

Furthermore, according to the present embodiment, it is possible to display, side-by-side, graphs/numerical tables prepared by a plurality of students on the teacher communication device 20 as an information display device. Display in such a form demonstrates high browsability and has high frequencies of its utility value in class, etc. In addition, identification information such as the names of preparers of graphs/numerical tables can be displayed along with the graphs/numerical tables themselves, and thus making it easy for a user to understand the displayed information.

The present invention is not limited to the above-mentioned embodiments and may be modified in various forms without departing from the scope of the invention at the practical phase. The respective embodiments may be carried out suitably in combination, and in that case, combined effects can be obtained. Furthermore, the above-mentioned embodiments include various inventions, and various inventions can be extracted by a combination selected from the disclosed structural requirements. For example, even if some structural requirements are deleted from all of the structural requirements disclosed in the embodiments, the configuration, in which the structural requirements have been deleted, can be extracted as an invention, if the problems can be solved and the effects can be obtained by the configuration.

What is claims is:

1. A data processing method executed by a server, the method comprising:
receiving, from an outside of the server, input data which is data for designating a function expression and at least one type of operation to be executed using the function expression, the at least one type of operation being selected from one or more types of operations, without receiving a request for sharing a result of at least one operation corresponding to the received at least one type of operation;
in response to the receiving the input data, executing the at least one operation based on the received input data, and transmitting at least one result of the executed at least one operation to the outside of the server, without storing the result of the executed at least one operation in a non-transitory memory;
Re-receiving, from the outside of the server, the input data which is the data for designating the function expression and the at least one type of operation, and receiving the request for sharing the result of the at least one operation corresponding to the re-received at least one type of operation along with the input data;
in response to the re-receiving the input data, re-executing the at least one operation corresponding to the re-received at least one type of operation, based on the re-received input data, and storing, in the non-transitory memory, a result of the re-executed at least one operation and at least one pointer corresponding to the result of the at least one operation one-to-one so that the result of the re-executed at least one operation is associated with the at least one pointer.

2. The data processing method according to claim 1, further comprising:
in response to receiving, from the outside of the server, a request for transmitting information designated by a pointer, reading, from a memory, a result of the operation associated with the pointer, the result of the operation being selected from among results of the at least one operation stored in the memory; and
transmitting the read result of the operation to the outside of the server.

3. The data processing method according to claim 1, wherein the at least one operation includes at least one of:
(i) a first operation which is a calculation of plot-point coordinates of a graph corresponding to the function expression designated by the input data; and
(ii) a second operation which is a calculation of numerical table values of a numerical table corresponding to the function expression designated by the input data.

4. The data processing method according to claim 1, wherein the input data further designates at least one numerical range for the at least one operation to be executed in addition to the function expression and the at least one type of operation to be executed, and wherein in the re-executing the operation and storing the result, further storing, in the non-transitory memory, the at least one numerical range is stored along with the result of the at least one operation in the non-transitory memory so that the at least one numerical range is associated with the at least one pointer.

5. A data processing method to be executed by a client device which communicates with the server that performs the method according to claim 1, the method comprising:
receiving a user operation for inputting data designating the function expression in an input device of the client device; and
in response to the receiving the user operation, transmitting, to an outside of the client device, the data designating the function expression and at least one type of operation to be executed so that the server can receive the data as the input data.

6. The data processing method according to claim 5, further comprising:
receiving the at least one result transmitted by the server; and
displaying at least one of a graph and a numerical table on a display device of the client device based on the received at least one result.

7. The data processing method according to claim 6, further comprising:
accepting an instruction based on a user operation for sharing at least one of the function expression, the graph, and the numerical table displayed on the display device of the client device; and
in response to the accepting the instruction for sharing, transmitting, to the outside of the client device, a request for the sharing so that the server can receive the request for the sharing.

8. The data processing method according to claim 6, further comprising:
accepting an instruction based on a user operation for sharing the function expression displayed on the display device of the client device; and
in response to the accepting the instruction for sharing, transmitting, to the outside of the client device, data designating, as at least one type of operation, a first operation and a second operation so that the server can receive the data as the input data, wherein the first operation is a calculation of plot-point coordinates of a graph corresponding to the function expression designated by the input data, and the second operation is a calculation of numerical table values of a numerical table corresponding to the function expression designated by the input data.

9. The data processing method according to claim 6, further comprising:
accepting an instruction based on a user operation for sharing the graph displayed on the display device of the client device; and
in response to the accepting the instruction for sharing, transmitting, to the outside of the client device, data designating a first operation as at least one type of operation so that the server can receive the data as the input data, wherein the first operation is a calculation of plot-point coordinates of a graph corresponding to the function expression designated by the input data.

10. The data processing method according to claim 6, further comprising:
accepting an instruction based on a user operation for sharing the numerical table displayed on the display device of the client apparatus; and
in response to the accepting the instruction for sharing, transmitting, to the outside of the client device, data designating a second operation as at least one type of operation so that the server can receive the data as the input data, wherein the second operation is a calculation of numerical table values of a numerical table corresponding to the function expression designated by the input data.

11. A client device which communicates with the server that executes the method according to claim 1, the client device comprising:
a controller and a memory, in execution by the controller, the memory has stored instructions for causing the controller to:
accept a user operation for inputting, in an input device of the client device, data designating a function expression; and
in response to the accepting the user operation, transmit, to the outside of the client, data designating a function expression and at least one type of operation to be executed so that the server can receive the data as input data.

12. The client device according to claim 11, wherein the client device is configured to:
receive at least one result transmitted by the server, display at least one of a graph and a numerical table on a display device of the client device, based on the received at least one result,
accept an instruction based on a user operation for sharing at least one of a function expression, the graph, and the numerical table displayed on the display device of the client device; and
in response to the accepting the instruction for sharing, transmit, to an outside of the client device, a request for the sharing so that the server can receive the request for the sharing.

13. A non-transitory recording medium having a program to cause a computer of a client device which communicates with a server that executes the method according to claim 1 to:
accept a user operation for inputting data designating a function expression in an input device of the client device; and
in response to the accepting the user operation, transmit, to the outside of the client device, data designating a function expression and at least one type of operation to be executed so that the server can receive the data as input data.

14. The client device according to claim 11, further configured to:
receive at least one result transmitted by the server;
display at least one of a graph and a numerical table on a display device of the client device;
accept an instruction based on a user operation for sharing at least one of the function expression, the graph and the numerical table displayed on the display device of the client device; and
in response to the accepting the instruction for sharing, transmit, to the outside of the client device, a request for the sharing so that the server can receive the request for the sharing.
